(19) United States
(12) Patent Application Publication
(10) Pub. No.: US 2006/0113226 A1
(43) Pub. Date: Jun. 1, 2006

(54) Method of locating or repairing damaged hollow fiber membranes or header or module assembly

(76) Inventors: Joseph Breitner, Thornhill (CA); Steven Kristian Pedersen, Burlington (CA)

Correspondence Address: JAECKLE FLEISCHMANN & MUGEL, LLP, 190 Linden Oaks, ROCHESTER, NY, 14625-2812, US

(21) Appl. No.: 11/244,976

(22) Filed: Oct. 6, 2005

Related U.S. Application Data
(60) Provisional application No. 60/617,849, filed on Oct. 12, 2004.

(30) Foreign Application Priority Data
Oct. 7, 2004 (CA) 2,484,096

(51) Int. Cl. B01D 63/02

(52) U.S. Cl. 210/95; 210/321.88; 210/321.89; 73/38; 73/40

(57) ABSTRACT

A membrane module may have, or may be fitted with, a transparent or translucent cover over a block of potting material holding hollow fiber membranes. To locate a defective fiber, a liquid may be placed over the ends of the membranes while the separating surfaces of the membranes are exposed to a gas and a pressure differential is applied to produce bubbles of the gas in the liquid through a defect requiring repair. The location of the defective fiber is revealed by the bubbles. The module may be repaired by closing the potted end of the defective fiber. The pressure differential may be applied by suction on the cover. The separating surfaces of the membranes may not need to be installed in a pressure vessel. The end of the defective membrane may be sealed by manipulating devices from outside of the cover such that the cover does not need to be removed. The cover may also be used to create a permeate cavity, or other part of a header assembly, used in normal operation of the module.

This is an application claiming the benefit under 35 USC 119(e) of U.S. Provisional Application Ser. No. 60/617,849 filed Oct. 12, 2004. Paragraphs 8 to 28, pages 9 to 11 and FIGS. 1 to 14 of U.S. Provisional Application Ser. No. 60/617,849 are incorporated herein by this reference to it.

### TECHNICAL FIELD

This document describes things that may be related to one or more of the fields of hollow fiber membranes, header assemblies, membrane modules, methods of making header assemblies or membrane modules, methods of locating a damaged membrane or methods of repairing a membrane or a module with a damaged membrane.

### BACKGROUND

The following discussion is not an admission that anything discussed below is prior art or part of the knowledge of persons skilled in any art.

Hollow fiber membranes are used in a variety of filtration, separation or transfer processes. However, the fibers occasionally break. Such breaks threaten the quality of the filtrate or other process products. Integrity tests done on a module or larger scale may be used to locate a defective module. The defective module can then be removed from service, but the particular broken fiber still needs to be located and the module still needs to be repaired. One method of locating a damaged fiber involves immersing a module into a tank of water. A source of pressurized air is connected to a header of the module to pressurize the lumens of the fibers. The pressurized air passes through the broken fiber and produces a train of bubbles. A technician follows the train of bubbles to locate the broken fiber. To repair the module, the technician plugs the broken end or ends of the broken fiber. This method, however, suffers from various problems. For example, it is often difficult to follow the bubble trail through a large tank to the damaged fiber, particularly in modules having a large number of fine fibers. In some such modules, it is also not possible to repair fibers in certain parts of the fiber bundle. Further, locating and repairing the loose ends of broken fibers is time and labor intensive.

### SUMMARY

The following summary is intended to introduce the reader to this disclosure but is not intended to define or limit any claimed or disclosed invention.

Aspects of this disclosure relates to header or module assemblies. One header assembly has a plurality of hollow fiber membranes with their ends sealed in a block of a potting medium. The potting medium is sealed to a cover such that the ends of the membranes are open to a plenum formed between the cover and the potting medium. The cover has a port allowing fluid communication between the outside and inside of the plenum. The cover may optionally have additional re-sealable openings allowing temporary access to the plenum. The cover is translucent or transparent, allowing the ends of the membranes to be observed from outside of the cover. The cover and port, or ports, are further arranged such that a liquid can be placed in the plenum to a depth covering the ends of the membranes while a vacuum is applied to a port.

Other aspects of this disclosure relate to methods of locating a broken or damaged fiber. In one method, the separating surfaces of the fibers are exposed to a gas, for example air. A liquid, for example water, is placed over the ends of the fibers. A pressure differential is then applied between the free surface of the liquid over the ends of the fibers and the separating surface of the membranes, at a pressure sufficient to create a bubble of the gas through a defect of a size that would require repair. The liquid is then observed, for example through a transparent cover over the liquid, for the presence of a bubble. A bubble produced at the end of a damaged fiber, if any, indicates the fiber end, and therefore the fiber, having the defect. Optionally, the location of the fiber end corresponding to the damaged fiber may be marked for later re-identification.

Other aspects of this disclosure relate to methods of repairing a module having a damaged fiber. In one method, a module is repaired by sealing an open end or the open ends of a damaged fiber that are fixed in a potting material. In one example, an end is sealed by applying a sealing material to the fiber end through a port or opening in a header cover. Optionally, the fiber end may first be prepared to accept the sealing material. Further optionally, the sealing material may be cured by applying an energy source though the wall of the cover. Yet further optionally, an opening may be created in the wall of the cover to enhance access to the fiber with the opening closed after the fiber end has been sealed. In another example, an energy source is directed through the cover to melt the fiber end shut.

### BRIEF DESCRIPTION OF THE DRAWINGS

FIGS. 1 through 7 show a portion of a first header assembly, steps in a first method of locating a damaged fiber and a first method of repairing a module.

FIG. 8 shows a portion of a second header assembly.

FIG. 9 shows a second method of repairing a damaged module.

FIGS. 10 through 12 show alternate covers for header assemblies.

FIG. 13 shows a second method of locating a damaged fiber.

FIG. 14 shows a portion of a third header assembly.

### DETAILED DESCRIPTION

Various apparatuses or processes will be described below to provide an example of an embodiment of each claimed invention. No embodiment described below limits any claimed invention and any claimed invention may cover processes or apparatuses that are not described below. The claimed inventions are not limited to apparatuses or processes having all of the features of any one apparatus or process described below or to features common to multiple or all of the apparatuses or processes described below. It is possible that an apparatus or process described below is not an embodiment of any claimed invention. The applicants, inventors or owners reserve all rights that they may have in any invention disclosed in an apparatus or process described below that is not claimed in this document, for example the right to claim such an invention in a continuing application, and do not intend to abandon, disclaim or dedicate to the public any such invention by its disclosure in this document.

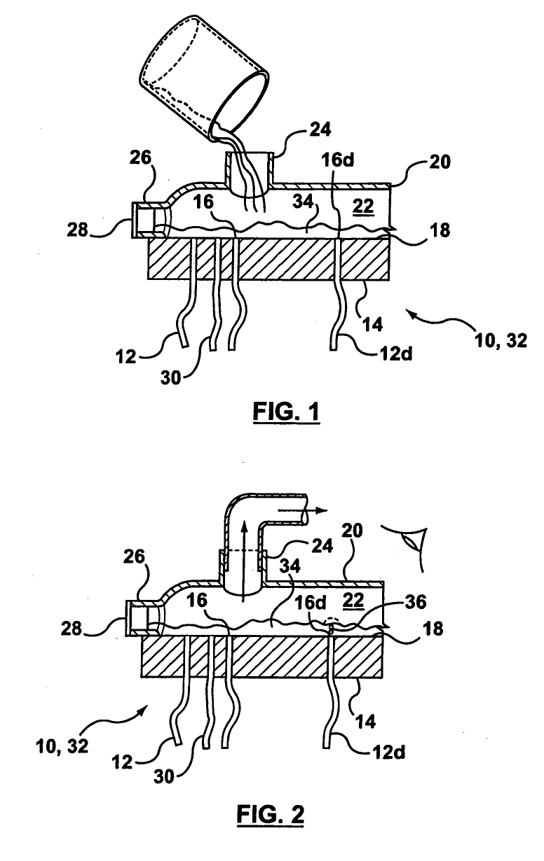

Referring to FIGS. 1 to 7, a module 10 has a plurality of hollow fiber membranes 12 with their ends 16 sealed in a block of potting material 14. In the Figures, the number of membranes 12 has been greatly reduced for clarity. The ends 16 of the membranes 12 are open at one face 18 of the potting material 14. In the embodiment illustrated, the ends 16 of the membranes 12 are machined flush with the face 28 of the potting material although, in other embodiments, the ends 16 of the membranes may protrude from the face 18 of the potting material 14. The module 10 may be one of various configurations. For example, second ends of the membranes 12, possibly not shown, may be held in a second block of potting material and may be either closed or open to a second cover. Any such second cover may have any ports closed during all or parts of a locating or repair procedure, for example during the steps described below in relation to FIG. 2. For further example, the membranes 12 may also be looped such that each membrane 12 has two open ends potted into potting material 14 or the membranes 12 may have loose second ends that are individually closed or sealed and not held in any potting material.

A translucent or transparent cover 20 forms a plenum 23 with the potting material 14. In the embodiment illustrated, the bottom edges of the cover 20 are sealed to the face 18 of the potting material 14, which is flat, by glue or welding. However, in other embodiments, alternate constructions may be used. For example, the potting material 14 may extend to, and adhere or be glued or welded to, the inside of the walls of the cover 20. The cover 20 may also be removably attached, for example by screwing through a gasketed flange into the potting material 14.

The cover 20 has a port 24 which allows fluid communication between the outside of the plenum 22, and the inside of the plenum 22, and to the ends 16 of the membranes 12. In the embodiment illustrated, the port 24 is a permeate port used, in normal operation of the module 10, to apply a suction to the membranes 12. The module 10 illustrated is ordinarily immersed in a tank of water or wastewater at ambient pressure, with the operating surfaces 30 of the membranes 12 in contact with the water or wastewater, and used to withdraw a filtered water permeate. However, in other embodiments, the module 10 and port 24 may have other uses, for example the withdrawal of fluids created by pressurizing a fluid against the operating surface 30 of the membrane 12 or the injection of a fluid into the membranes 12 to be permeated or filtered out through the separating surfaces 30 of the membranes 12. The module 10 may have a similar header assembly 32, comprising a cover 20, potting material 14 and open ends 16 of the membranes 12, at the opposed ends of the membranes 12, or the opposed ends of the membranes may be sealed but free, sealed in small, movable groups, sealed into another block of potting material, or otherwise arranged. Where the module 10 has membranes 12, each with a pair of open ends 16 in opposed header assemblies 32, both header assemblies 32 need to be treated as discussed below to repair the module 10. The cover 20 illustrated also has an access opening 26 with a selectively removable plug 28 although in other embodiments the port 24 may be used to perform the functions of the access opening 26, or a temporary opening may be made, or example by drilling a hole through the cover 20 and later sealing the hole when required.

In FIG. 1, the module 10 has been found to contain a damaged fiber 12d by an integrity test on the module 10. The damaged fiber may, for example, be broken or have a hole of unacceptable size. However, the location of the damaged fiber 12d is not yet known. The module 10 is removed from its tank and is held with the separating surfaces 30 of the fibers 12 exposed to a gas, for example air at ambient pressure. A layer of liquid 34, for example water, is poured into the plenum 22, for example through the port 24. The liquid 34 covers the ends 16 of the membranes 12, for example to a depth of about 1 cm.

In FIG. 2, a vacuum is applied to the port 24, at a pressure sufficient to draw gas, in an amount sufficient to create a bubble, through a defect requiring repair. Gas pulled through the damaged membrane 12d forms bubbles 36 in the liquid 34. Observation of the bubbles through the transparent or translucent cover 20 allows the end 16d of the damaged membrane 12d to be identified, for example by tracing the line of bubbles 36 back to the end 16d of the damaged fiber 12d or observing which end 16 the bubbles 36 emerge from. Optionally, the end 16d of the damaged membrane 12d may be marked to aid in later re-location, for example by placing a mark on the outside surface of the cover 20 directly over the end 16d of the damaged membrane 12d. Alternately, a laser pointer or other light emitting device may be held outside of the cover 20 so that it illuminates the end 16d of the damaged membrane 12d.

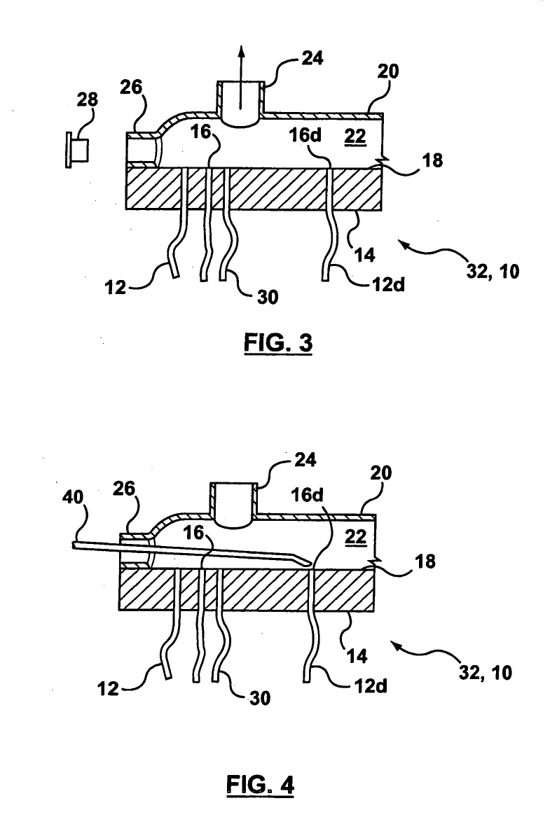

In FIG. 3, the vacuum source is closed or disconnected and the plug 28 removed from the opening 26. The liquid 34 is also removed from the plenum 22. This may be done, for example, by draining though the opening 26 or port 24, by sucking the liquid 34 into the membranes 12 by applying a vacuum to their other ends, or by applying a pressurized gas to the port 24. Alternatively, the liquid 34 may be removed by leaving the opening 26 open while applying a vacuum to the port 24 until the liquid 34 is evaporated or carried away.

In FIG. 4, a tool 40 is optionally inserted though the opening 26 to prepare the surface of the end 16d of the damaged fiber. The tool 40, and its use, may vary according the specific sealing method that will be used. For example, the tool 40 may be a vacuum or blower wand used to further dry the end 16d of the damaged membrane 12d. Alternately, the tool 40 may have a moving head and be used to smooth or roughen a portion of the face 18 of the potting material 14 or the end 16d of the damaged membrane 12d. Further alternatively, the tool 40 may be a tube used to disperse one or more chemical substances used to pre-treat the area to be sealed.

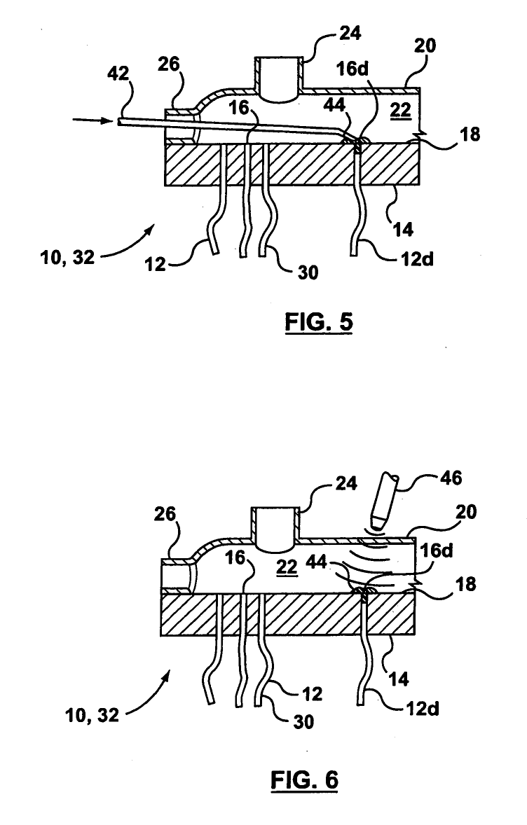

In FIG. 5, the end 16d of the damaged membrane 12d is sealed. A second tool 42 is inserted into the plenum 22, for example through the opening 26, and used to dispense a sealing material 44 onto, or into, the end 16d of the damaged membrane 12d. The sealing material 44 may be, for example, a resin, silicone or other substance.

In FIG. 6, the sealing material 44 is optionally treated to decrease its curing time. For example, an energy source 46 may be used from outside of the cover 20 to send energy to the sealing material. The energy may be in the form of electromagnetic waves or radiation such as light, infrared or ultraviolet radiation, or microwaves.

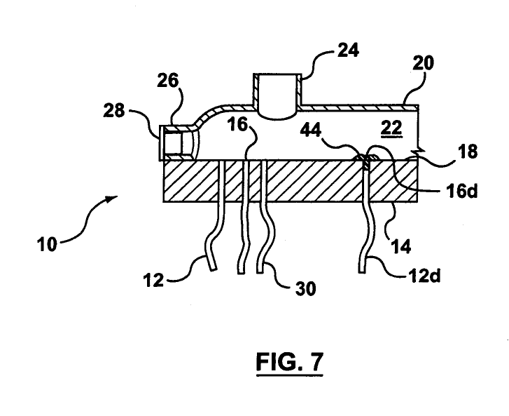

In FIG. 7, the access plug 28 has been replaced. The module 10 has been repaired. If the damaged membrane 12 has a second open end, the location or repair procedure or both may be repeated to seal the second open end and so further repair the module 10. Similarly, any other damaged membranes 12 in the module 10 may also be located and repaired. The integrity of the repair may be tested by repeating an integrity test on the module 10. Alternately, the steps described in relation to FIGS. 1 and 2 may be repeated to test the integrity of a repaired module 10.

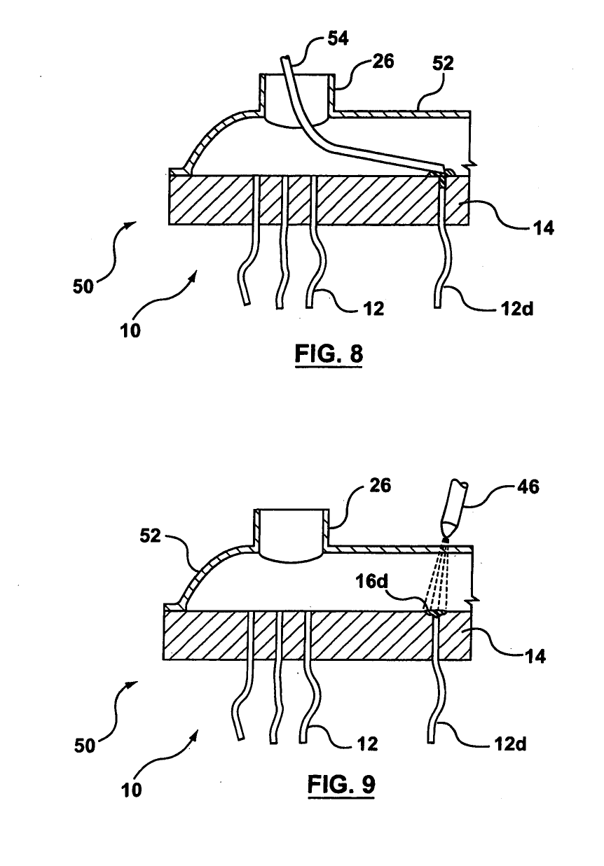

FIG. 8 shows a second header assembly 50. The second header assembly 50 has a block of potting material 14 and membranes 12 as before, but a second cover 52 has one or more ports 24, but no special access openings for use only in locating or sealing damaged membranes 12. A third tool 54, or other tools, used with this second header assembly 20 are bent, curved, flexible or otherwise adapted to allow use through a port 24.

FIG. 9 shows a second method of repairing a module 10. The second method is shown as used with the second header assembly 50 of FIG. 8, although it may also be used with other header assemblies. In the second method, the energy source 46 is used to provide energy at sufficient intensity to melt the end 16d of the damaged fiber 12d closed, optionally after vaporizing any remaining liquid from the end 16a of the damaged membrane 12a.

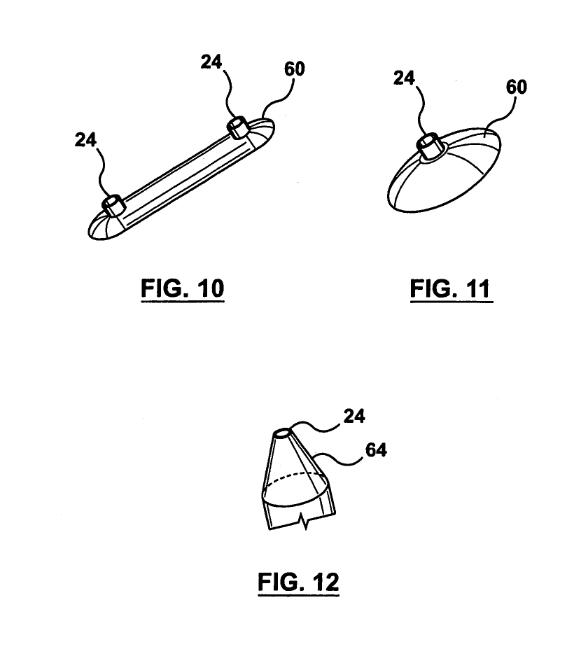

FIGS. 10 to 12 show further alternate covers. In FIG. 10, a third cover 60 has an elongated shape for use with an elongated or rectangular block of potting material. Two ports 24, one in each half of the third cover 60, are used to provide better access through the ports 24 to the ends of the membranes. In FIGS. 11 and 12, fourth and fifth covers 62, 64 are made in the shape of a solid of rotation for use with a cylindrical block of potting material 12. A single port 24 is placed on the axis of rotation to provide better access to membranes located around the edges of the bundle of membranes. The fourth cover 62 is a portion of a sphere while the fifth cover 64 is a cone. The height of the fifth cover 64 is made large to facilitate use of straight tools through the port 24. In any of the covers 20, 52, 60, 62, 64, additional ports 24 or openings 26 may be provided as desired to improve access to the membrane ends, or temporary openings may be made, for example by drilling holes through a wall of the cover 20, 52, 60, 62, 64, to facilitate locating or repair procedures, and closing the temporary holes, for example by welding or gluing a plug into the temporary hole, before the module 10 is returned to service.

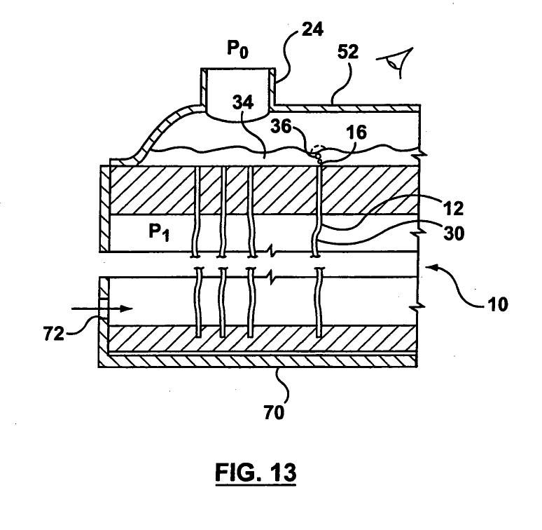

FIG. 13 shows a second method of locating a damaged membrane. The second method is like the first except that the pressure differential is applied by exposing the separating surface 30 of the membranes 12 to a pressurized gas such as air. To do this, the second header assembly 50 is sealed to a pressure vessel 70 containing the module 10. Pressurized air is provided to the pressure vessel 70 through a fitting 72. The pressure vessel 70 may be a part made particularly for use in a locating or repair procedure or may be all or part of a shell used with the module in normal operation. The port 24 may be exposed to air at ambient pressure. The method is shown with a module 20 having a second header assembly 50 at one end and closed fibers on the other end, but may also be used with other modules.

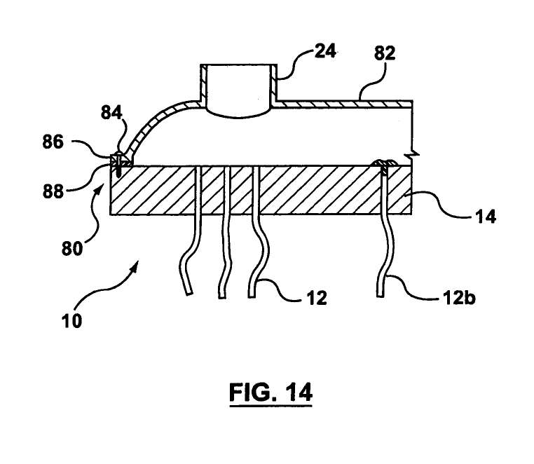

FIG. 14 shows a third header assembly 80 having a sixth cover 82. The sixth cover 82 is removable and replaceable against the potting material 14. The sixth cover 82 is removably attached to the potting material 14 by means of screws 84 screwed through a flange 86 of the sixth cover 82 and a gasket 88 between the flange 86 and potting material 14. The sixth cover 82 may be used in normal operation of the module 10 or may be used only for the locating or repair procedure. In the latter case, the sixth cover 82 is replaced with a different cover when the module 10 is used in service. In this way, the design of the sixth cover 82 can be tailored for the locating or repair procedure while a separate operating cover has a design tailored for the normal use of the membrane. Optionally, the sixth cover 82 may be disposable.

We claim:

1. A header assembly comprising:
a) a block of a potting medium;
b) a plurality of hollow fiber membranes with their ends sealed in the potting medium;
c) a cover sealed to the potting medium,
wherein
d) the cover and potting medium form a plenum;
e) the ends of the membranes are open to the plenum; and,
f) the cover is transparent or translucent.

2. The header assembly of claim 1 wherein the cover has a port allowing fluid communication between the inside and outside of the plenum.

3. The header assembly of claim 1 wherein the cover has an opening for providing access by a tool manipulated from outside of the cover to the ends of the membranes.

4. The header assembly of claim 3 having a plurality of ports or openings.

5. The header assembly of claim 1 having a centrally located port or opening.

6. The header assembly of claim 5 wherein the cover is a shape of rotation.

7. The header assembly of claim 1 wherein the cover is removable.

8. A method of detecting a damaged fiber in a module of hollow fiber membranes comprising the steps of:
a) placing a liquid over the surface of a potting material to cover open ends of the membranes;
b) exposing the separating surface of the membranes to a gas;
c) applying a pressure differential between the separating surfaces of the membranes and the liquid, the pressure differential being sufficient to create a bubble of the gas through a defect of a size requiring repair; and,
d) identifying an end of a membrane from which bubbles, if any, are produced.

9. The method of claim 8 further comprising marking the end of the damaged membrane.

10. The method of claim 8 wherein the pressure differential is provided by applying a vacuum to the surface of the liquid.

11. The method of claim 10 wherein the suction is provided by applying a source of negative pressure to the transparent or translucent cover over the liquid.

12. The method of claim 10 wherein the separating surface of the membranes is exposed to air at ambient pressure

13. The method of claim 8 wherein the module has a header assembly comprising:
a) a block of a potting medium;
b) a plurality of hollow fiber membranes with their ends sealed in the potting medium; and,
c) a cover sealed to the potting medium,
wherein
d) the cover and potting medium form a plenum;
e) the ends of the membranes are open to the plenum; and,
f) the cover is transparent or translucent.

14. A method of repairing a module with a damaged membrane comprising the steps of applying a sealing material from a tool inserted through a port or opening in a cover over a header assembly of the module to seal an end of a damaged membrane.

15. The method of claim 14 further comprising applying an energy source to the sealing material through the cover.

16. The method of claim 14 wherein the opening is made in the cover to accept the tool and then closed after the sealing material is applied.

17. A method of repairing a module with a damaged membrane comprising the steps of applying an energy source though a transparent or translucent cover to an end of a damaged membrane to melt the end of the damaged fiber closed.

18. The method of claim 14 wherein the damaged membrane is located by a method of detecting a damaged membrane in a module of hollow fiber membranes comprising the steps of:
a) placing a liquid over the surface of a potting material to cover open ends of the membranes;
b) exposing the separating surface of the membranes to a gas;
c) applying a pressure differential between the separating surfaces of the membranes and the liquid sufficient to create a bubble of the gas through a defect of a size requiring repair; and,
d) identifying an end of a membrane from which the bubbles, if any, are produced.

19. The method of claim 14 wherein the module has a header assembly comprising:
a) a block of a potting medium;
b) a plurality of hollow fiber membranes with their ends sealed in the potting medium; and,
c) a cover sealed to the potting medium,
wherein
d) the cover and potting medium form a plenum;
e) the ends of the membranes are open to the plenum; and,
f) the cover is transparent or translucent.

20. The method of claim 8 wherein the module has a header assembly comprising, a block of a potting medium; a plurality of hollow fiber membranes with their ends sealed in the potting medium; and, a cover sealed to the potting medium, wherein, the cover and potting medium form a plenum; the ends of the membranes are open to the plenum; and, the cover is transparent or translucent.
